(19) United States
(12) Patent Application Publication
(10) Pub. No.: US 2024/0152937 A1
(43) Pub. Date: May 9, 2024

(54) Contact Interest Intelligence

(71) Applicant: SAP SE, Walldorf (DE)

(72) Inventors: Christopher Salvatore, Washington D.C., MD (US); William Lawley, Palo Alto, CA (US); James Pagel, Coatesville, PA (US); Pavan Kumar Yanmanagandla, Dowingtown, PA (US); Subrahmanyam Kappagantula, West Chester, PA (US); Michael Hollitscher, New York, NY (US); Asha Iyengar, Weston, FL (US); Benjamin Smokovich, San Antonio, TX (US)

(21) Appl. No.: 18/053,658

(22) Filed: Nov. 8, 2022

(51) Int. Cl. G06Q 30/02; G06F 21/62

(52) U.S. Cl. CPC G06Q 30/0201; G06F 21/6263; G06Q 30/0205

(57) ABSTRACT

Systems and methods determine and record legitimate interest in a consistent and quantitative manner. A contact interest engine receives from a source (e.g., sales/marketing automation), data regarding interaction with a contact. The interaction data may include a topic, a country, and consent by the contact. The CII processes the interaction data according to appropriate rules, in order to calculate a Legitimate Interest (LI) point score. The LI point score may be affected by decay over elapsed time from communication with the contact. The LI point score is recorded and then referenced in order to determine an existence of LI. Based upon the LI, appropriate actions may be output (e.g., permission to communicate with the contact; issued alerts; recommendations for follow-up activities). Reproducibility of the LI determination allows marketing/sales professionals (having limited expertise in privacy rules/regulation) to reach out with confidence to prospective contacts (e.g., customers).

### BACKGROUND

Unless otherwise indicated herein, the approaches described in this section are not prior art to the claims in this application and are not admitted to be prior art by inclusion in this section.

The desire to maintain privacy for electronic communications, has been the subject of legislation enacted in a number of different jurisdictions. One such law is the Global Data Protection Regulation (GDPR).

The GDPR references a legitimate interest, to serve as a legitimate basis for an entity communicating with a contact (e.g., a seller reaching out to a prospective customer). However, the criteria for finding a legitimate interest may change over time, and moreover such legitimate interest may be defined differently in various jurisdictions.

### SUMMARY

Embodiments relate to systems and methods that determine and record legitimate interest in a consistent and quantitative manner. A contact interest engine receives from a source (e.g., sales/marketing automation), data relating to interaction with a contact. The interaction data may include a topic, a country, and consent by the contact. The engine processes the interaction data according to appropriate rules, in order to calculate a Legitimate Interest (LI) point score. The LI point score may be affected by decay over elapsed time from communication with the contact. The LI point score is recorded and then referenced in order to determine an existence of LI. Where LI is determined to exist, appropriate actions may be output—e.g., alerts; permission(s) to communicate with the contact; recommendation(s) for follow-up activities. The reproducibility of the LI determination allows marketing/sales professionals (having limited expertise in privacy rules/regulation) to reach out with confidence to prospective contacts (e.g., customers).

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified overview of an architecture configured to implement contact interest intelligence according to the example.

FIGS. 4A-4B show details of the CII engine of FIG. 3.

FIG. 5 shows an overview of categories for Legitimate Interest determination.

FIG. 6 shows details of CII points according to the example.

FIGS. 7A-7B show an example record of contacts.

FIGS. 8-10 show automation according to the example.

FIG. 11-12 show a flow for next suggested step planning in the example.

FIGS. 13A-B show a data subject interest profile according to the example.

FIG. 14 illustrates hardware of a special purpose computing machine configured to implement contact interest according to an embodiment.

FIG. 15 illustrates an example computer system.

### DETAILED DESCRIPTION

Described herein are methods and apparatuses that implement contact interest intelligence. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

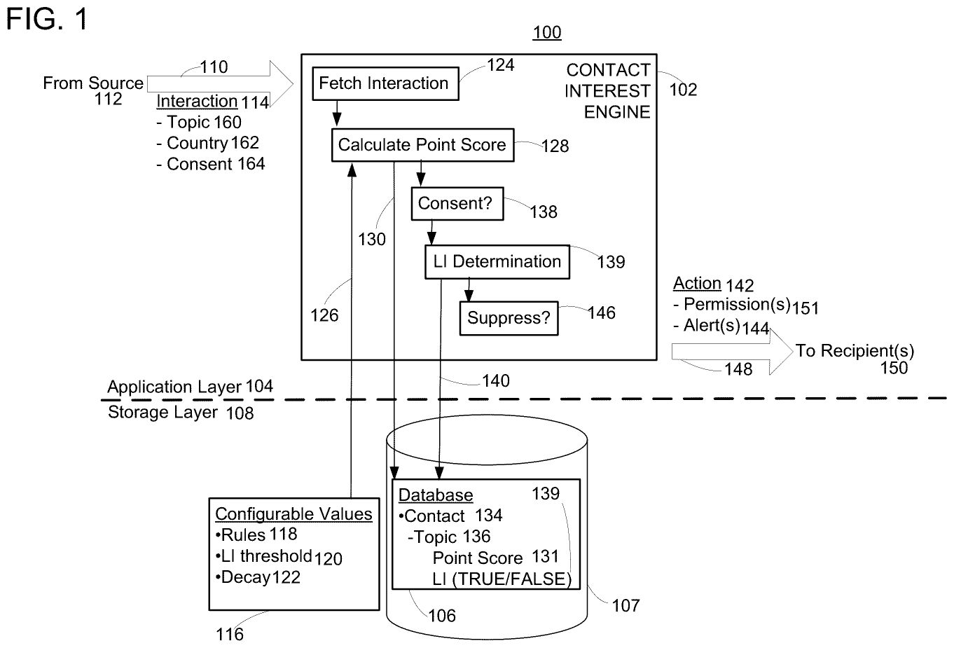

FIG. 1 shows a simplified view of an example system configured to implement contact interest according to an embodiment. Specifically, a Contact Interest engine 102 located in an application layer 104, is in communication with a database 106 that is present in non-transitory computer readable storage medium 107 within a storage layer 108.

The contact interest engine is configured to receive as input 110 from a source 112, interaction data 114. The source may comprise marketing or sales automation. The interaction data may be received from a database of such marketing or sales automation.

A set of configurable values 116 are also maintained in the storage layer. Such configurable values may comprise rules 118 for processing the incoming interaction data. Also present as a configurable value may be a LI threshold 120 and/or decay 122 parameter(s). According to certain embodiments, the configurable values themselves may be stored in the database 106.

The contact interest engine fetches 124 the interaction data. This fetching may be accomplished by pushing or pulling. This fetching may occur on a periodic basis (e.g., through a polling mechanism), or may be triggered by the occurrence of the specific interaction.

The interaction data that is fetched by the contact interest engine, may comprise various elements. One element may be a topic 160 of the interaction. Another element may be a country 162 of the interaction (e.g., for determining applicable laws). Still another element may be consent 164 to communication.

Next, the contact interest engine references 126 information that is present in the storage layer, in order to calculate 128 a LI point score from the interaction data. This calculation may be based upon rules that are part of the configurable values. Calculation of the LI point score may consider factors including consent and/or decay over time.

The contact interest engine stores 130 the LI point score 131 in the database 106. The database may be organized in a hierarchical manner, e.g., according to contact 134 and topic 136.

Next, the contact interest engine considers 138 whether (explicit or implicit) consent from the contact is present. According to some embodiments, the presence or absence of consent may influence the level of a LI threshold value.

Then, the contact interest engine determines 139 whether LI is in fact present. According to some embodiments, this determination may involve referencing a LI threshold as just mentioned.

Where no LI is found, this is recorded 140 in the database (e.g., by setting a FALSE value). Such a finding could trigger a subsequent action 142, e.g. to issue an alert 144.

Where LI is found, the contact interest engine may perform an additional phase of determining whether grounds exist to suppress 146 communication with the contact. Bases for suppressing communication with a contact for whom LI exists, can include but are not limited to one or more of:
Do-Not-Contact (DNC) lists;
export controls;
sanctioned party lists;
embargoed country lists;
litigation holds;
others (e.g., as specified by rules).

Again, a decision to suppress communication could trigger a follow-on action, such as sending an alert.

Assuming that LI is found and no basis for suppression exists, the contact interest engine may then perform additional processing to provide an output 148 in the form of an action to a recipient 150. Such an action may be to issue a permission 151 to a downstream interface, that in turn communicates with sales and/or marketing systems to permit communication with the contact.

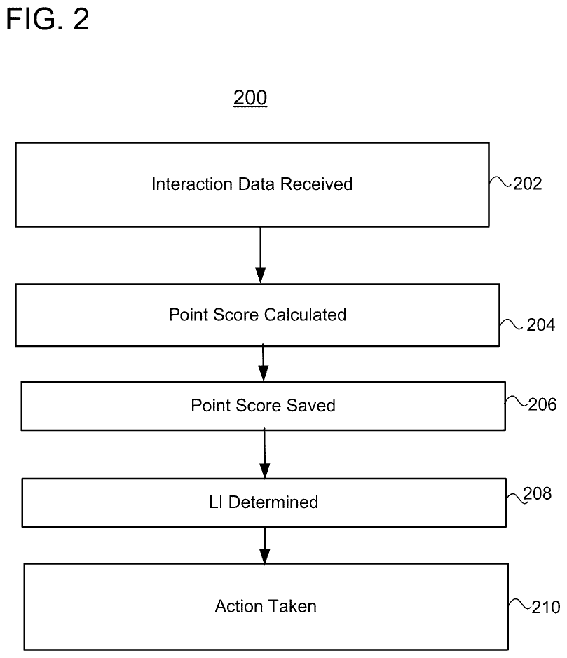

FIG. 2 is a flow diagram of a method 200 according to an embodiment. At 202, interaction data is received.

At 204, a legitimate interest point score is calculated from the interaction data. At 206, the legitimate interest point score is stored in a non-transitory computer readable storage medium.

At 208, the existence of legitimate interest is determined from the legitimate interest point score. At 210, an action is taken based upon the legitimate interest.

Embodiments may offer one or more benefits. One possible benefit is enhanced confidence.

That is, embodiments eliminate any guesswork by an individual marketing or sales representative, in determining whether LI exists to allow reaching out to a contact (e.g., prospective customer). A record of LI is established, managed, and made available to consuming systems on a seller's enterprise network.

Further details regarding the implementation of contact interest intelligence according to various embodiments, are now provided in connection with the following example. In this example, the interest value is referred to as Legitimate Interest (LI).

### Example

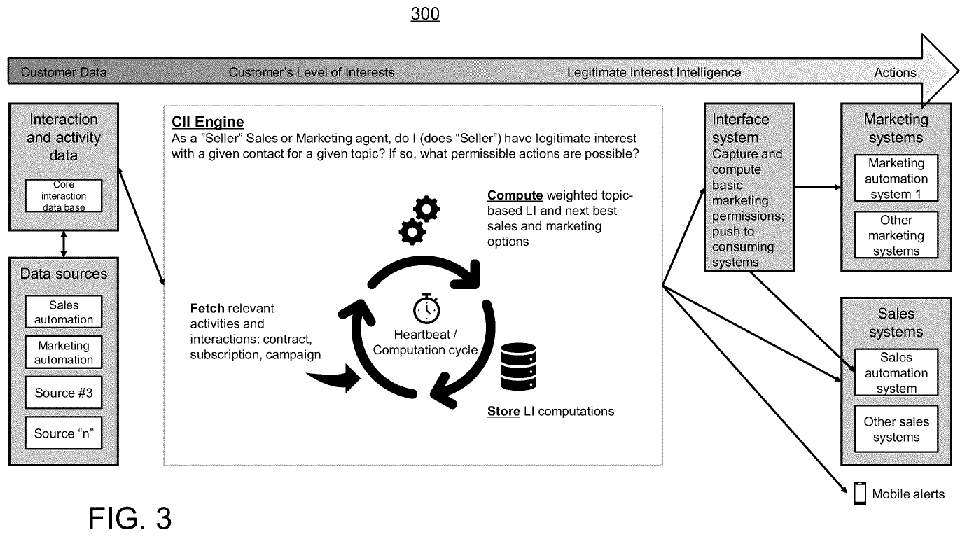

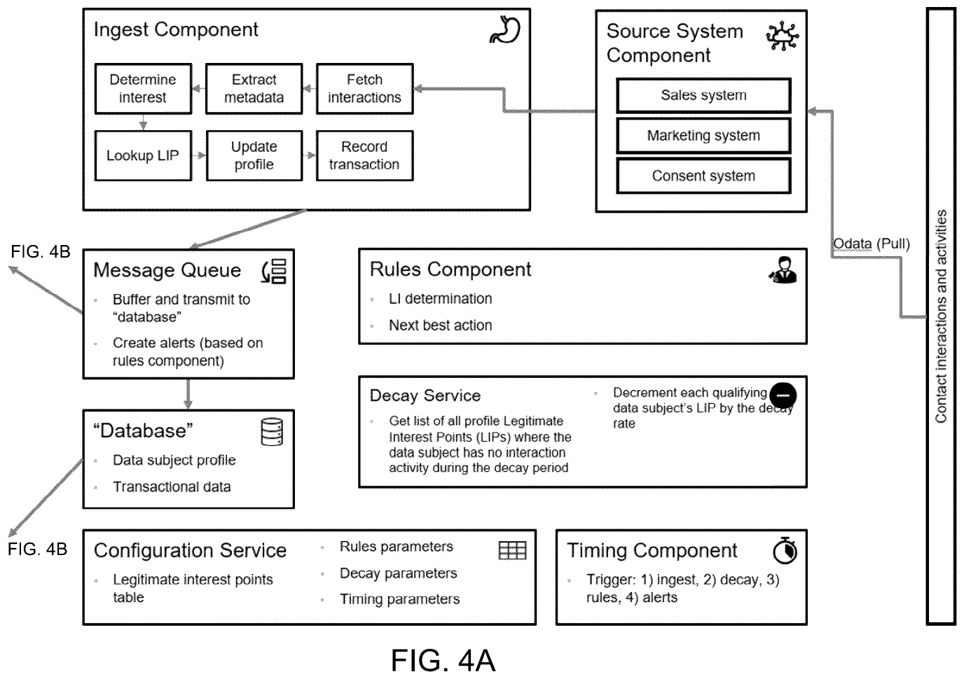

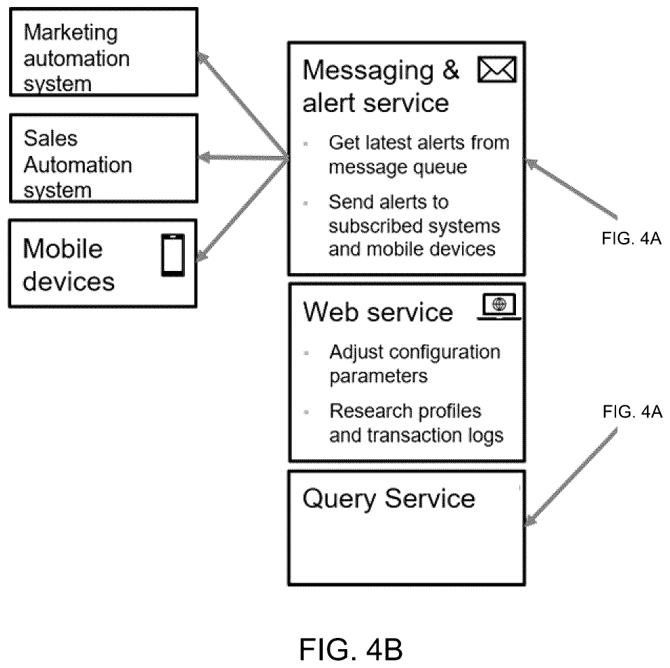

FIG. 3 shows a simplified overview of an architecture configured to implement contact interest intelligence according to the example. FIGS. 4A-4B show details of the CII engine of FIG. 3. These and other figures of the example are now discussed in connection with the following process flow.

Step 0: Service Configuration

Numerous configurable service-wide parameters (described below) are used to control and fine tune the behavior of the Contact Interest Intelligence Service and the resulting legitimate interest computations.

Legitimate Interest Points: Each interaction type is assigned a legitimate interest point value and stored in a configuration table and used during subsequent processing steps.

The selected values generally reflect the level of relationship value established by the customer for the performance of the interaction. These values are adjusted over time using manual and machine learning methods as described in the Automation section.

Examples of configurable values can include but are not limited to:
Legitimate Interest Threshold—minimum number of legitimate interest points required for legitimate interest to be TRUE.
Decay Interval—a frequency the decay service is executed.
Decay Threshold—amount of time that must pass without an interaction before decay will be computed.
Decay Factor—amount of decay applied to relevant LI records.
Business Rules: Various business rules are pre-defined and stored in tables or other rules engines for subsequent processing. The legitimate interest determination is the result of the execution of these business rules for each interaction. The resulting values are stored with each customer profile.

For exemplary business rules, countries may be classified into one of four groups:
1) explicit countries with no concept of legitimate interest;
2) explicit countries with explicit interest;
3) implicit countries with a lenient view of legitimate interest; and
4) implicit countries with a stricter view of legitimate interest.

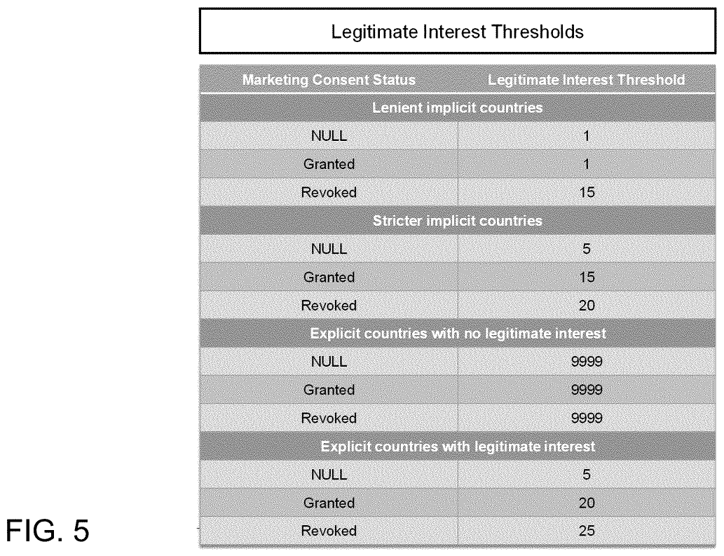

Each country is classified into one of four categories based on their respective data privacy laws. FIG. 5 shows an overview of the four categories for Legitimate Interest Determination.

Inputs for Legitimate Interest Determination may comprise:
Interest: the Customer Contact's interest (e.g., topic) from the interaction.
Country: the Customer Contact's country from the interaction
Consent: the marketing consent from the consent management system.

One formula for determining Legitimate Interest may be summarized as follows:
If
   the value of the customer interest>=the legitimate interest threshold,
then
   Legitimate Interest=TRUE,
else
   Legitimate Interest=FALSE
If either
   the resulting Legitimate Interest is TRUE, or
   Consent is Granted or NULL,
then
   Marketability=TRUE,
else
   Marketability=FALSE

Step 1: Identify and Manage Legitimate Interest

Sellers and Customers interact on a continuous basis throughout the customer lifecycle. These interactions result in the creation of various data records across the Sellers' enterprise systems. The Interactions are consumed on a regular and ongoing basis, either real-time or in batch.

Interactions are identified and consumed by the Service. The customer profile is established by extracting the identifying information from the interaction record.

Customer interests are then identified by extracting relevant metadata from the interactions and comparing that metadata against the known corporate metadata.

Each interaction type is mapped to a master set of interaction types as defined in the service configuration and is assigned a predetermined legitimate interest point value. This value is added to the customer's profile.

With the customer profile established and the customer interests and corresponding legitimate interest points identified, the legitimate interest is computed based on country specific rules.

In the absence of customer interactions over some predetermined period of time, the perceived relationship between the customer and the company weakens or decays. This weakening is expressed as a formula of legitimate interest points, decay interval, decay threshold, and the decay factor.

In particular, Legitimate Interest points are perishable and decay over time in the absence of customer driven interactions. This decay service is configured by decay interval, decay threshold, and decay factor. The decay interval is the time (number of seconds) the system waits until performing a point decay. The decay threshold is the amount of time that must pass without an interaction before a decay will be applied. The decay factor is the percentage of points subtracted for relevant customers.

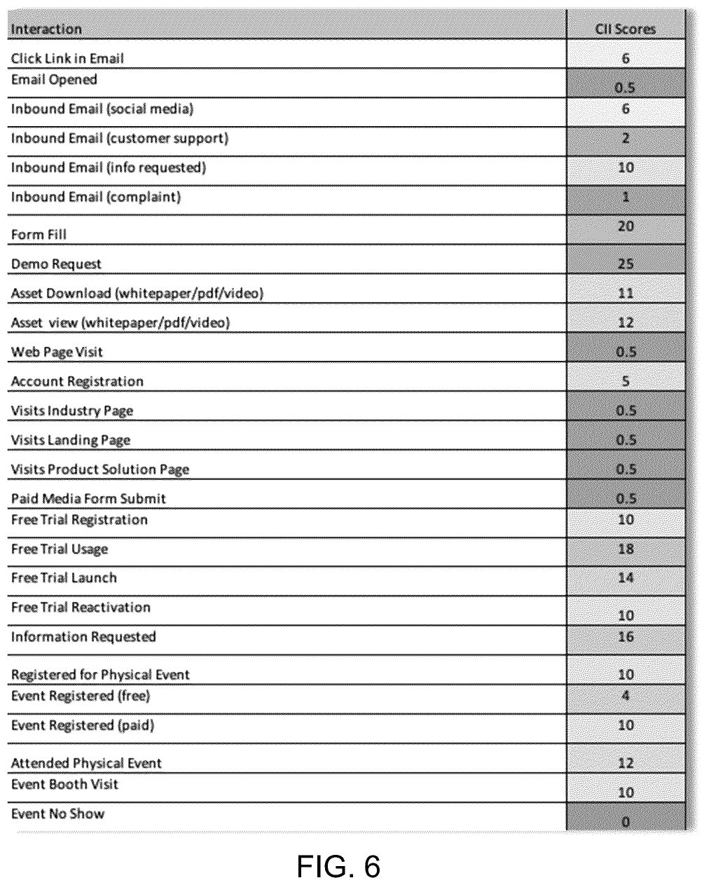

FIG. 6 shows details of CII points according to an example. This is a sample possible listing of CII scoring for the various sales and marketing interactions that are shown. Based on feedback from the sales and/or marketing end users, these interactions can be weighted according to recency, relevancy, and/or impact.

These scores are then updated in the CII system once they happen, and the decay engine also starts post activity. The threshold to qualify for legitimate interest for a particular “seller/business”, is configurable.

Each interaction type is assigned a legitimate interest point value and stored in a configuration table and used during subsequent processing steps. The selected values generally reflect the level of relationship value established by the customer for the performance of the interaction. These values are adjusted over time using manual and machine learning methods as described below in connection with automation.

Step 2: Application of Suppressions

Suppressions may be applied for one or more reasons. One reason could be a government do not contact list. That is, each country government may have a nationwide Do-Not-Contact (DNC) list.

This list can be made available electronically to legal entities to consume this information, in order to adhere to the wishes of the respective country's citizens. The Service consumes these DNC lists and adds this information to the respective Customer Profile.

Another possible basis for suppression, is export controls. The service consumes a list of restricted export countries including a list of persons or entities, to restrict export of goods, technology, related technical data, and certain services in the interest of protecting the national security and domestic economy.

Another possible basis for suppression, is a sanctioned party list. The Service consumes the Sanctioned Party List from a known, authorized service. Customers flagged as “denied” or “restricted” receive a flag in their respective Customer Profile.

Yet another possible basis for suppression, is an embargoed country. The Service consumes the list of Embargoed Countries. Any Customer whose country appears on the Embargoed Country list receives a flag in their respective Customer Profile.

Still another possible basis for suppression, is a litigation hold. Customers in litigation with the Company must not receive sales solicitations or marketing communications. Once litigation between a Company and a Customer occurs, that information is consumed by the Service, and that information is recorded in the respective Customer Profile.

Sales suppression may be implemented automatically and/or manually. Automated sales suppression can involve a Company attempting to enter into a contract with a Customer, marketing communications with the Customer should be suspended until the contracting phase has ended. The Service consumes all Sales activities from a CRM system (and related customer and contracting systems) to ascertain the opportunity and contract status. Based on that status, the Service records this information in the respective Customer Profile.

In a similar fashion to the Automated recording of a Sales Suppression, there may be circumstances where an automated approach to enforcing a Sales Suppression may not work. In such cases, the Sales Representative can manually send the relevant suppression information to the Service. The Service consumes this manually entered suppression information and records this information in the respective Customer Profile.

Step 3: Identify Suggested Actions and Relevant Content

CII can provide suggested next business steps based on the two factors of customer interest and legal legitimate interest. The suggested next steps mapping, planning, and business strategy need to first be agreed upon by the business. The function of aligning next suggested assets, events etc. can be determined considering the level of legitimate interest the contact has, and avoiding any duplication of contact “interest” assets previously reviewed by the contact.

CII can be aligned with different databases managing research, whitepapers, solution documentation and upcoming events, which can provide suggested next steps based on the specific topic and level of legitimate interest. On the customer interest side, we can determine based on type of previous interactions, a detailed level of material which would be pertinent to a customer at the stage of the lifecycle with the company. We can align very specific/targeted marketing material for the topic of interest for the customer assuming previous downloads, views etc.

From a legitimate interest standpoint, CII will consider the various levels of legitimate interest with a customer, and based on the high, medium or low engagement.

From a data privacy or legitimate interest perspective CII can determine if the legitimate interest is:
1. based on contract performance
2. personalized content, or
3. keeping the customer up to date or requesting feedback.

As such data privacy laws may also govern what we can and cannot recommend to a contact. Overall, CII will optimize the highest value “customer interest material” and suggest that is shared to the customer via whatever sales or marketing interface it is used.

Step 4: Notification Systems

Since CII is designed around time-based transactions for updated interest and legitimate interest, there is the possibility to highlight changes for “buyers” to alert sales and marketing teams to a change in the status of a “buyer”, or suggested actions to take via the CII consuming systems. CII would only generate the “file” needed for the notification; the consuming system would need to need the infrastructure to understand and activate the feed.

Since CII will be connected to various sales and marketing systems via a feed of data (data event) API's, CII will have the ability to trigger notifications on changes that affect the sales/marketing person when available and added to the system. Some example notifications which could arise can include but are not limited to the following.
New information which now allows the sales/marketing to reach out since a contact has made the threshold of legitimate interest points based on recent interactions.
New information which shows a “updated” suppression such as do not contact me, revoke consent, or customer has enough legitimate interest threshold decay for communications.
Changes to data for a “buyer” such as new interactions, which provides new detail to help with next step planning or communications.
Changes to data for a “buyer” such that their legitimate interest will soon decay and they will no longer meet the threshold which will allow the “seller” to contact the “buyer” prior to the relationship change.

Apart from desktop software notifications for interest and legitimate interest, there is also the ability to send a mobile alert to end users indicating there has been a change in a contact or set of contacts.

The mobile alert is optional, calling for the support infrastructure of the consuming systems, like the desktop function CII would provide the files. This mobile alert will be driven by the operations sales and marketing systems, and the sales/marketing person will have the ability to opt into/request these messages.

Step 5: Automation

From an automation perspective, CII is a running engine which ingests interactions, computes interest and legitimate interest, and provides an output to consuming sales and marketing systems. This can happen in a turnkey fashion, with core parameters and rules set by hard coding or an admin console.

CII may employ Machine Learning (ML) to allow for a deeper level of analysis for more mature automation, and decision-making with some aspects of the customer data such as suggested next steps, or deeper analysis of sales/marketing patterns for strategic planning enhancements. Additional ML aspects (such as sales cycle dynamics, influential marketing patterns which will allow better marketing reports, and updated calibration options) may be considered.

Additionally CII may have the ability to provide a quick view of summarized contact data within the consuming systems (provided these consuming systems have related functionality), with a concatenated view of previous interactions with a hover function in the UI to show how the contact reached the threshold of legitimate interest (e.g., x emails, x downloads, x events, etc.) A further examination of details can be provided when the user clicks on the quick view, since the data could be substantial and we are focusing of performance of connected systems.

The various parameters outlined in Step 0 above, may be evaluated on an ongoing basis. Traditional statistical methods and/or ML techniques may be used to calibrate and optimize system outputs.

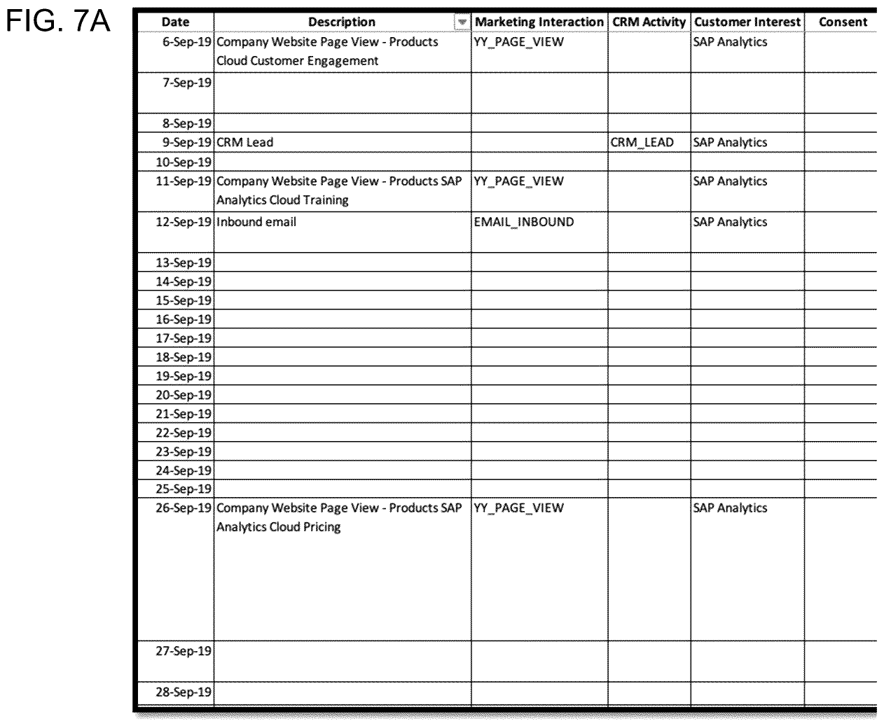

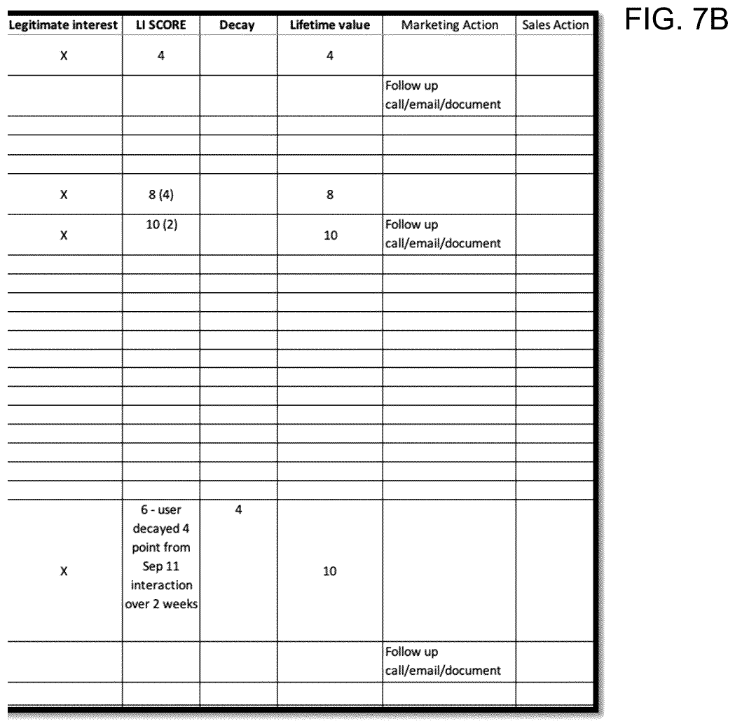

FIGS. 7A-B show details of a record of contacts under CII. Here, there is no contract. However, legitimate interest is present since the “contact” interacted and got points for each interaction. The interest and the eventual decay of legitimate interest within the engine over time, is also shown.

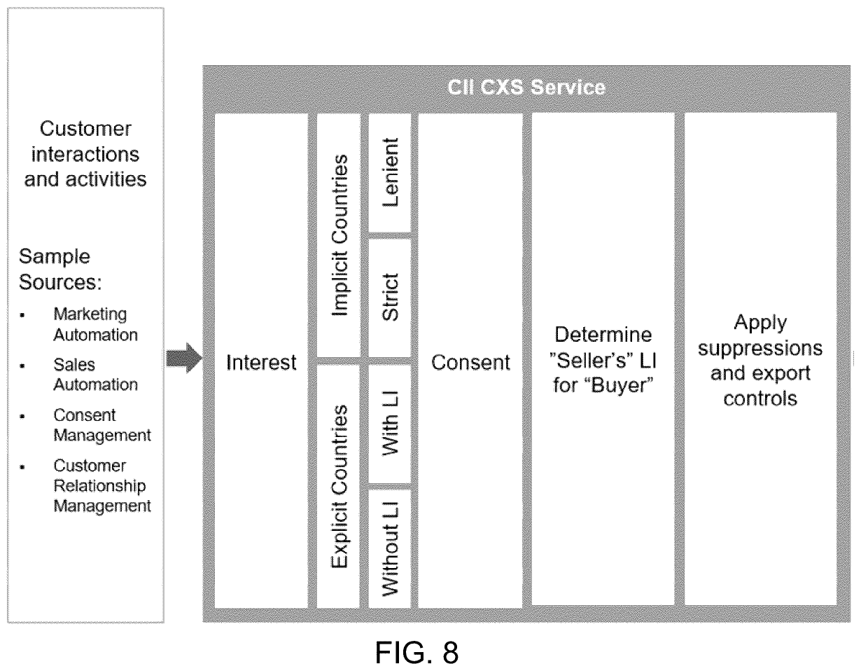

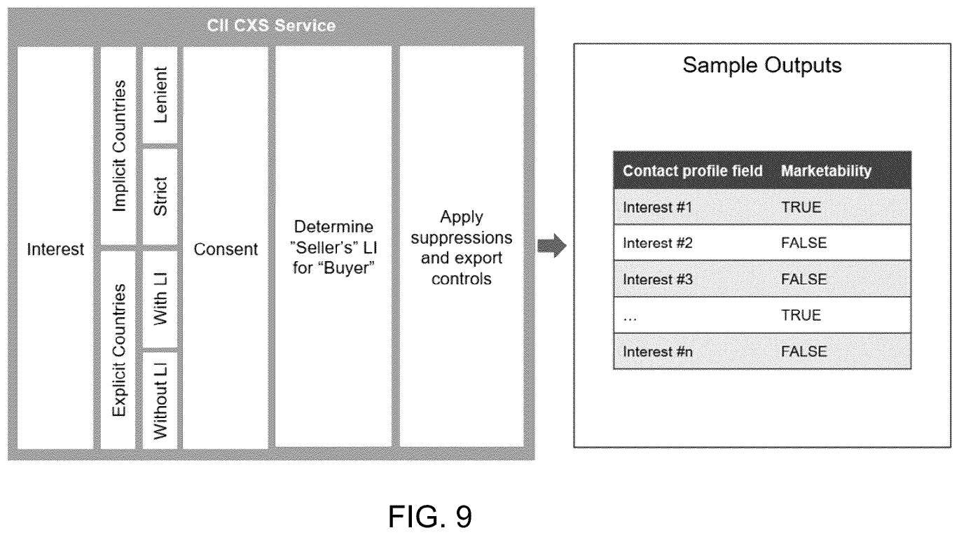

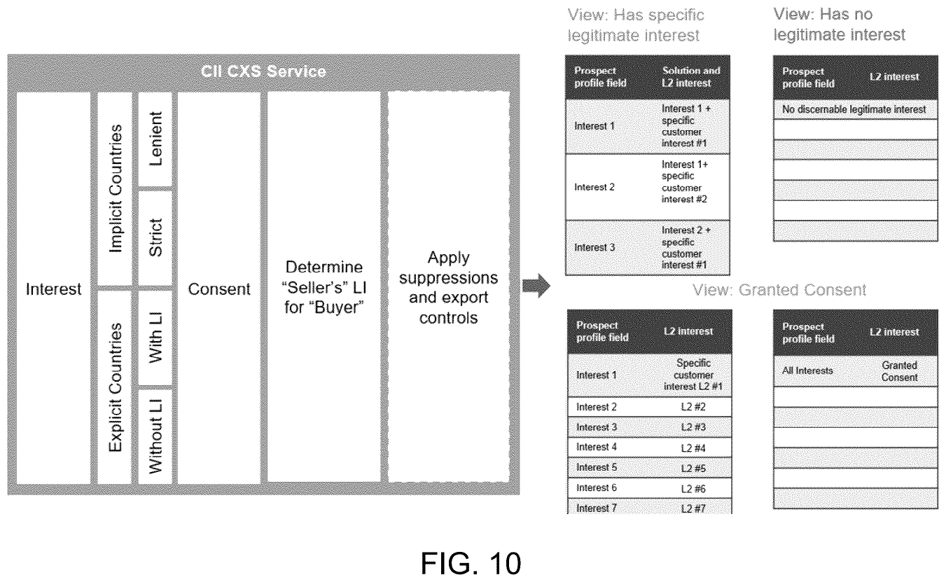

Further details regarding sales and marketing automation are described in connection with FIGS. 8-10. CII will process the Marketability (marketing) and Reachability (sales) based on customer interests and legal constraints. The CII system takes the respective interactions, and extrapolates the “buyer” interest, considers the data privacy laws/rules globally, determines if they have provided consent previously, determines if the “buyer” has legitimate interest, applies export controls and suppressions and sends a file out to the consuming marketing and sales systems.

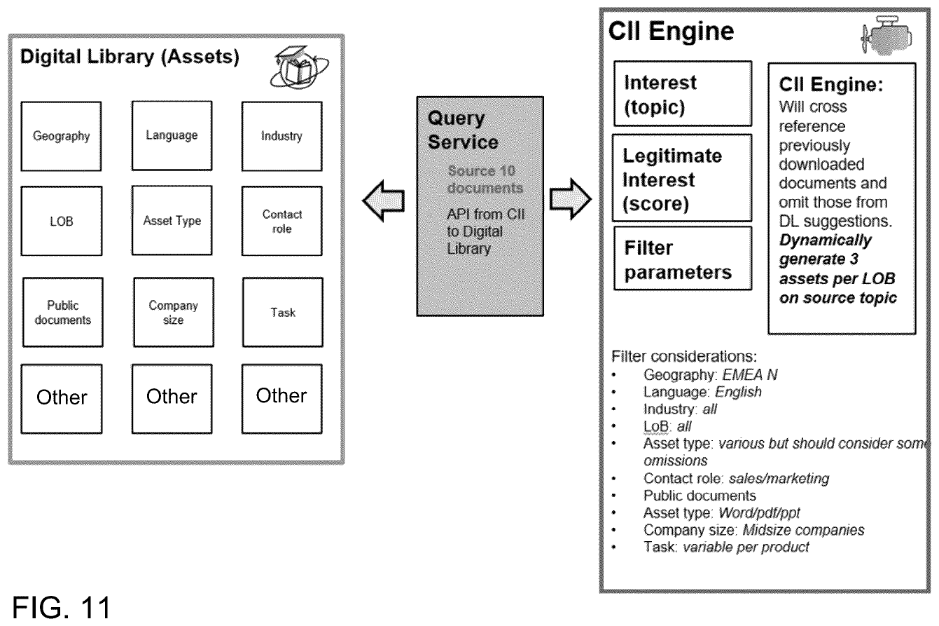

Further details regarding the identification and suggestion of actions and relevant content are now provided in connection with FIGS. 11-13B. CII can provide suggested next business steps based upon the factors of customer interest and legal legitimate interest.

Suggested follow-on steps (e.g., mapping, planning, and business strategy) may be agreed upon by the business. The function of aligning next suggested assets, events etc. can be determined considering the level of legitimate interest the contact has, and avoiding any duplication of contact “interest” assets previously reviewed by the contact.

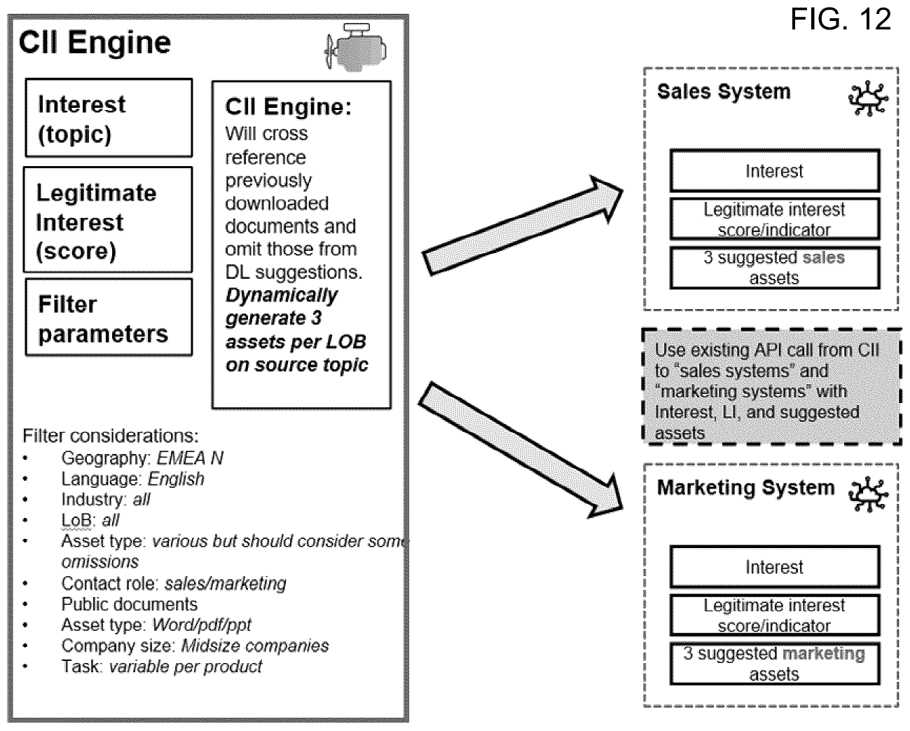

The process of FIGS. 11-12 occurs after the country rules run and “Seller's” LI has been determined. With each CII engine processing cycle, 3 assets are identified and stored as part of the data subject's CII profile. Then the updated customer interests, legitimate interest values, and links to these 3 assets are sent to Sales and Marketing automation systems.

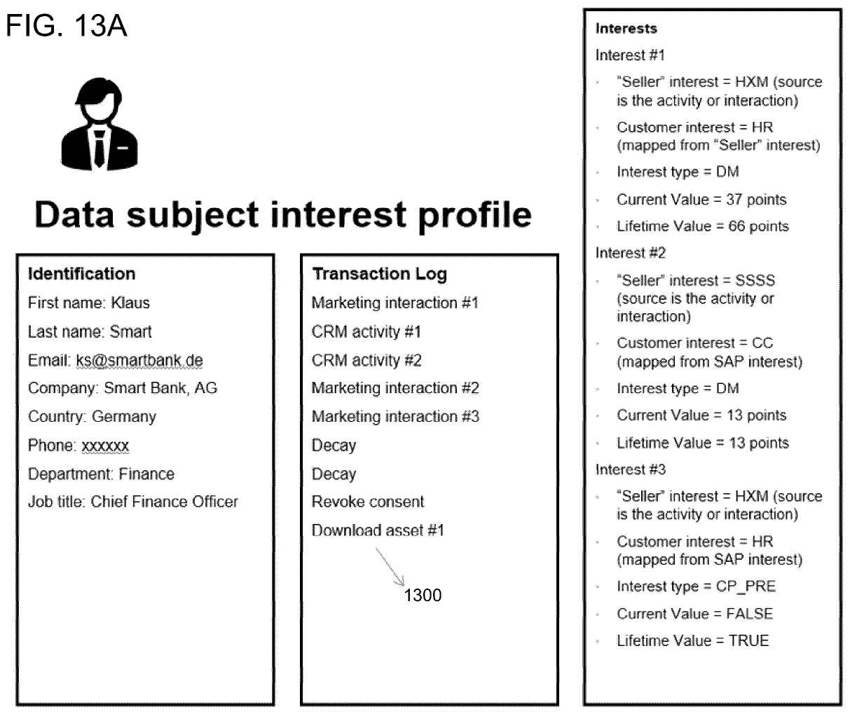

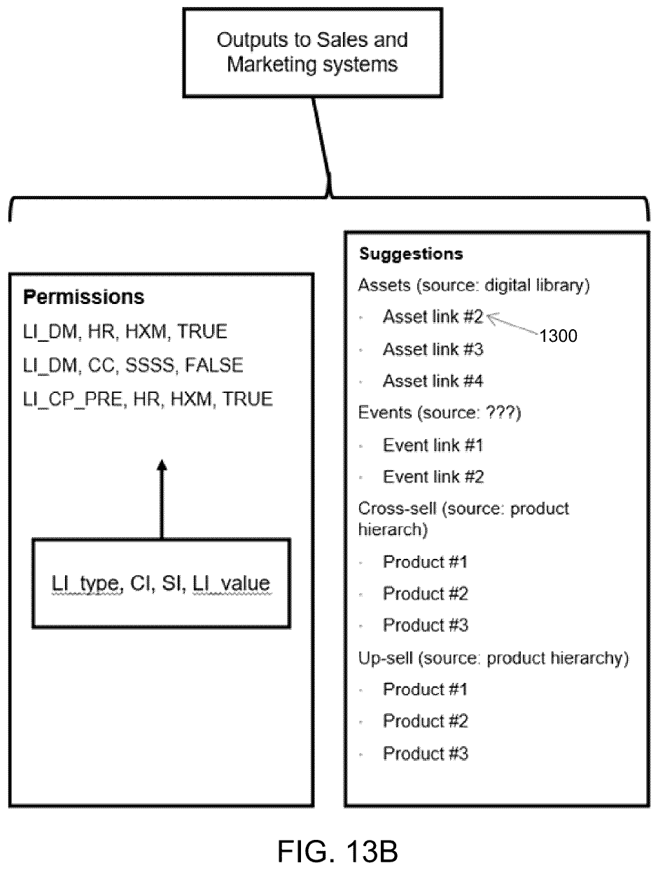

FIGS. 13A-13B show the data subject interest profile according to this example. Previously downloaded assets are excluded from current suggestions (indicated by 1300).

Returning now to FIG. 1, there the particular embodiment is depicted with the contact engine as being located outside of the database. However, this is not required.

Rather, alternative embodiments could leverage the processing power of an in-memory database engine (e.g., the in-memory database engine of the HANA in-memory database available from SAP SE), in order to perform various functions as described above.

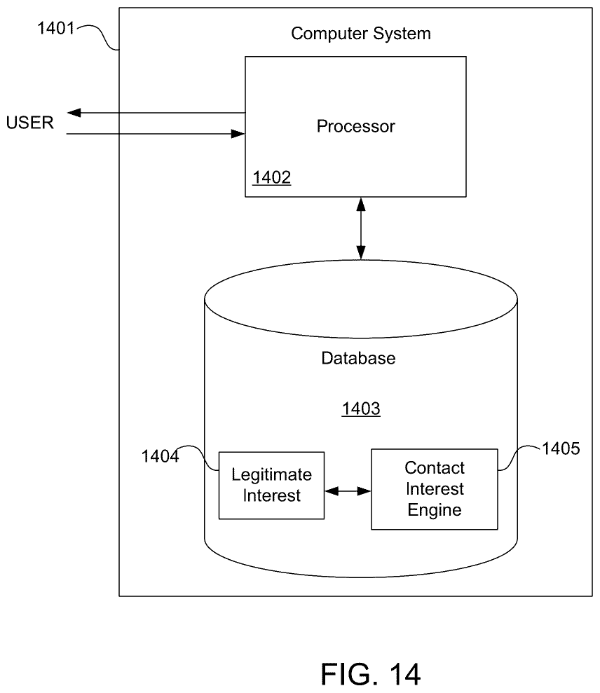

Thus FIG. 14 illustrates hardware of a special purpose computing machine configured to implement a communications interface according to an embodiment. In particular, computer system 1401 comprises a processor 1402 that is in electronic communication with a non-transitory computer-readable storage medium comprising a database 1403. This computer-readable storage medium has stored thereon code 1405 corresponding to a contact interest engine. Code 1404 corresponds to a legitimate interest. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented system and methods comprising:
receiving interaction data with a contact;
calculating a legitimate interest point score from the interaction data;
storing the legitimate interest point score in a non-transitory computer readable storage medium;
determining an existence of legitimate interest from the legitimate interest point score; and
based upon the legitimate interest, taking an action.

Example 2. The computer implemented system and method of Example 1 wherein determining the existence of legitimate interest comprises determining that the legitimate interest point score exceeds a threshold.

Example 3. The computer implemented system and method of Example 2 wherein the interaction data comprises a country, and the threshold is based upon the country.

Example 4. The computer implemented system and method of Examples 1, 2, or 3 wherein the interaction data comprises a consent, and the determining is based upon the consent.

Example 5. The computer implemented system and method of Example 1, 2, 3, or 4 further comprising prior to taking the action, determining that no suppression is appropriate.

Example 6. The computer implemented system and method of Example 1, 2, 3, 4, or 5 wherein the action comprises sending a permission to communicate with the contact.

Example 7. The computer implemented system and method of Examples 1, 2, 3, 4, 5, or 6 wherein calculating the legitimate interest point score considers a decay.

Example 8. The computer implemented system and method of Examples 1, 2, 3, 4, 5, 6, or 7 wherein:
the non-transitory computer readable storage medium comprises an in-memory database; and an in-memory database engine of the in-memory database calculates the legitimate interest point score.

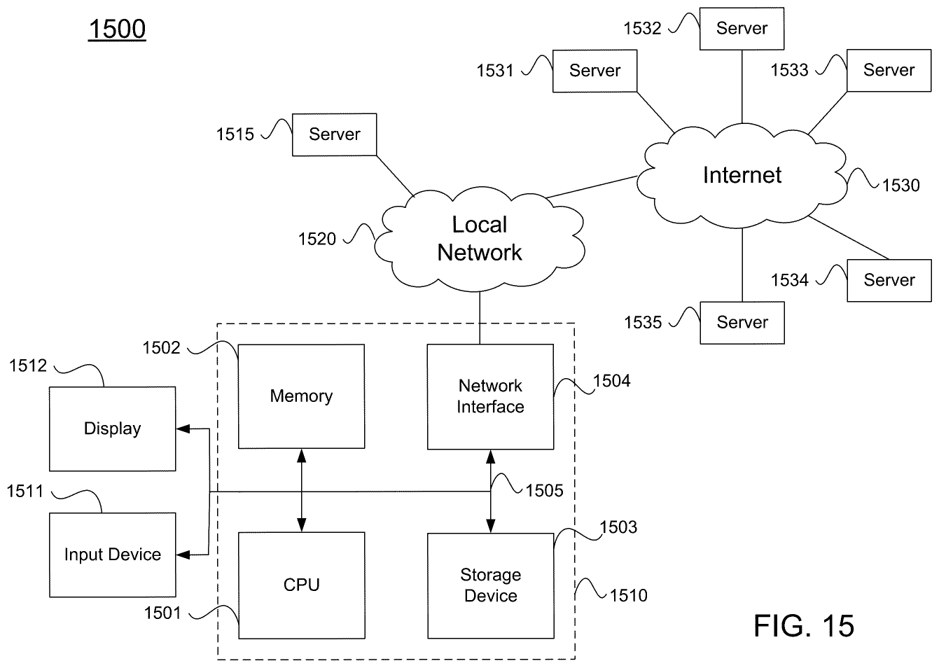

An example computer system 1500 is illustrated in FIG. 15. Computer system 1510 includes a bus 1505 or other communication mechanism for communicating information, and a processor 1501 coupled with bus 1505 for processing information. Computer system 1510 also includes a memory 1502 coupled to bus 1505 for storing information and instructions to be executed by processor 1501, including information and instructions for performing the techniques described above, for example. This memory may also be used for storing variables or other intermediate information during execution of instructions to be executed by processor 1501. Possible implementations of this memory may be, but are not limited to, random access memory (RAM), read only memory (ROM), or both. A storage device 1503 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1503 may include source code, binary code, or software files for performing the techniques above, for example. Storage device and memory are both examples of computer readable mediums.

Computer system 1510 may be coupled via bus 1505 to a display 1512, such as a Light Emitting Diode (LED) or liquid crystal display (LCD), for displaying information to a computer user. An input device 1511 such as a keyboard and/or mouse is coupled to bus 1505 for communicating information and command selections from the user to processor 1501. The combination of these components allows the user to communicate with the system. In some systems, bus 1505 may be divided into multiple specialized buses.

Computer system 1510 also includes a network interface 1504 coupled with bus 1505. Network interface 1504 may provide two-way data communication between computer system 1510 and the local network 1520. The network interface 1504 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 2404 sends and receives electrical, electromagnetic, or optical signals that carry digital data streams representing various types of information.

Computer system 1510 can send and receive information, including messages or other interface actions, through the network interface 1504 across a local network 1520, an Intranet, or the Internet 1530. For a local network, computer system 1510 may communicate with a plurality of other computer machines, such as server 1515. Accordingly, computer system 1510 and server computer systems represented by server 1515 may form a cloud computing network, which may be programmed with processes described herein. In the Internet example, software components or services may reside on multiple different computer systems 1510 or servers 1531-1535 across the network. The processes described above may be implemented on one or more servers, for example. A server 1531 may transmit actions or messages from one component, through Internet 1530, local network 1520, and network interface 1504 to a component on computer system 1510. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving interaction data with a contact;
calculating a legitimate interest point score from the interaction data;
storing the legitimate interest point score in a non-transitory computer readable storage medium;
determining an existence of legitimate interest from the legitimate interest point score; and
based upon the legitimate interest, taking an action.

2. A method as in claim 1 wherein determining the existence of legitimate interest comprises determining that the legitimate interest point score exceeds a threshold.

3. A method as in claim 2 wherein:
the interaction data comprises a country; and
the threshold is based upon the country.

4. A method as in claim 1 wherein:
the interaction data comprises a consent; and
the determining is based upon the consent.

5. A method as in claim 1 further comprising:
prior to taking the action, determining that no suppression is appropriate.

6. A method as in claim 5 wherein determining that no suppression is appropriate comprises referencing at least one of:
a Do-Not-Contact (DNC) list;
an export control;
a sanctioned party list;
an embargoed country list; and
a litigation hold.

7. A method as in claim 1 wherein the action comprises sending a permission to communicate with the contact.

8. A method as in claim 1 wherein calculating the legitimate interest point score considers a decay.

9. A method as in claim 1 wherein:
the non-transitory computer readable storage medium comprises an in-memory database; and
an in-memory database engine of the in-memory database calculates the legitimate interest point score.

10. A non-transitory computer readable storage medium embodying a computer program for performing a method, said method comprising:
receiving interaction data with a contact, the interaction data including a country;
calculating a legitimate interest point score from the interaction data;
storing the legitimate interest point score in a database of the non-transitory computer readable storage medium;
determining an existence of a legitimate interest from the legitimate interest point score and the country; and
based upon the legitimate interest, outputting a permission to communicate with the contact.

11. A non-transitory computer readable storage medium as in claim 10 wherein:
the existence of the legitimate interest is determined from the legitimate interest point score exceeding a threshold that is based upon the country.

12. A non-transitory computer readable storage medium as in claim 11 wherein:
the interaction data comprises a consent; and
the existence of the legitimate interest is determined at least in part from the consent.

13. A non-transitory computer readable storage medium as in claim 10 wherein calculating the legitimate interest point score considers a decay.

14. A non-transitory computer readable storage medium as in claim 10 wherein the method further comprises:
prior to taking the action, determining that no suppression is appropriate by referencing at least one of:
a Do-Not-Contact (DNC) list;
an export control;
a sanctioned party list;
an embargoed country list; and
a litigation hold.

15. A non-transitory computer readable storage medium as in claim 10 wherein:
the interaction data includes a topic; and
the legitimate interest is recorded in the database according to the topic.

16. A computer system comprising:
one or more processors;
a software program, executable on said computer system, the software program configured to cause an in-memory database engine of an in-memory database to:
receive interaction data with a contact;
calculate a legitimate interest point score from the interaction data;
store the legitimate interest point score in the in-memory database;
determine an existence of legitimate interest from the legitimate interest point score; and
based upon the legitimate interest, take an action.

17. A computer system as in claim 16 wherein in-memory database engine considers a decay in calculating the legitimate interest point score.

18. A computer system as in claim 16 wherein the action comprises outputting a permission to communicate with the contact.

19. A computer system as in claim 16 wherein prior to taking the action, the in-memory database engine is further configured to:
determine that no suppression is appropriate by referencing at least one of:
a Do-Not-Contact (DNC) list;
an export control;
a sanctioned party list;
an embargoed country list; and
a litigation hold.

20. A computer system as in claim 16 wherein:
the interaction data comprises a consent and a country; and
existence of the legitimate interest is determined from the legitimate interest point score exceeding a threshold that is based upon the consent and the country.
